(19) United States
(12) Patent Application Publication
(10) Pub. No.: US 2024/0401373 A1
(43) Pub. Date: Dec. 5, 2024

(54) ELECTRIC UNLOCKING DEVICE FOR A PUSH BAR LATCH

(71) Applicant: YI FAN LIAO, TAOYUAN CITY (TW)

(72) Inventor: YI FAN LIAO, TAOYUAN CITY (TW)

(21) Appl. No.: 18/355,118

(22) Filed: Jul. 19, 2023

(30) Foreign Application Priority Data
Jun. 1, 2023 (TW) 112205552

(51) Int. Cl. E05B 47/00; E05B 65/10

(52) U.S. Cl. CPC E05B 47/0001; E05B 65/1053; E05B 2047/0016; E05Y 2400/32; E05Y 2400/44

(57) ABSTRACT

A electric unlocking device for a push bar latch, comprising: a base frame having an external sliding slot; a linear motor having a stepping stud, the stepping stud is equipped with a stud return spring, and the stepping stud has a binding rod; an unlocking unit having a pair of side plate and an end plate, the side plate has a pair of internal sliding slot, and the end plate has a non-circular hole; a transmission unit having a limit oval head rivet and a non-circular barrel, the non-circular barrel sets through the non-circular hole and makes the limit oval head rivet arranged inside the unlocking unit, and makes the transmission unit combine with the binding rod; a position sensor, arranged on the base frame to define the pre-unlock reference position of the unlocking unit; a control unit; and an unlocking connecting rod.

### BACKGROUND OF THE INVENTION

### 1. Field of the Invention

The invention relates to an electric unlocking device for a push bar latch, especially the one who has an electric unlocking function.

### 2. Description of the Related Art

As showing in FIG. 1, the push bar latch 10 can be unlocked by pushing the push rod 11 to go out, and the setting range of the push rod 11 is very large, so that the push bar latch 10 is very convenient for unlocking and is often used in exit doors; however, since the push bar latch 10 has the characteristics of being very convenient to unlock and automatically return, but for the disabled such as riding in a wheelchair, it may still be difficult for pushing the push rod 11 to unlock and go out, so the push bar latch 10 is increased with the electric unlocking function not only facilitates easy access for the disabled, but also has enter control functions.

### SUMMARY OF THE INVENTION

It is a primary objective of the present invention to provide an electric unlocking device for a push bar latch, especially the one who has the electric unlocking function of a push bar latch.

It is another objective of the present invention to ensure that electric unlocking device does not fail.

In order to achieve the above objectives, the present invention comprise: a base frame having an external sliding slot; a linear motor having a stepping stud installed on the base frame, the stepping stud extends and retracts relative to the external sliding slot and is equipped with a stud return spring, and the head end of the stepping stud has a binding rod; an unlocking unit having a pair of side plate and an end plate arranged in the base frame, the pair of side plate has a pair of internal sliding slot relative to the external sliding slot, and the end plate has a non-circular hole; a transmission unit having a limit oval head rivet and a non-circular barrel, the non-circular barrel sets through the non-circular hole and makes the limit oval head rivet arranged inside the unlocking unit, and makes the transmission unit combine with the binding rod, then let the unlocking unit slide along with the extension of the stepping stud; a position sensor, arranged on the base frame to define the pre-unlock reference position of the unlocking unit; a control unit, electrically connected to the linear motor and the position sensor; an unlocking connecting rod, the outer end of the unlocking connecting rod is combined with a push bar returning unit, and the inner end is provided with an unlocking pin, the unlocking pin sets through the pair of external sliding slot and the pair of internal sliding slot.

Moreover, when the control unit sets the number of unlocking step, it firstly makes the stepping stud retract then confirm the pre-unlock reference position through the position sensor, then makes the stepping stud continue to push the unlocking unit outward in a slow speed until the stepping stud having out-of-step phenomenon, thus when the out-of-step phenomenon occurs, sets the running step of the stepping stud as maximum step, and the unlocking step of the stepping stud is set to be lower than the maximum step and be memorized, then the stepping stud retracts to let the unlocking unit be at the pre-unlock reference position, and then the stepping stud is unlocked according to the unlocking step, wherein, the unlocking step is 94%±5% of maximum step, and the position sensor includes a limit switch, a micro switch a proximity switch, a optocoupler, a hall device or a laser diode which can sensing distance.

### BRIEF DESCRIPTION OF THE DRAWINGS

FIG. 1 is a schematic diagram illustrating structure of the push bar latch;

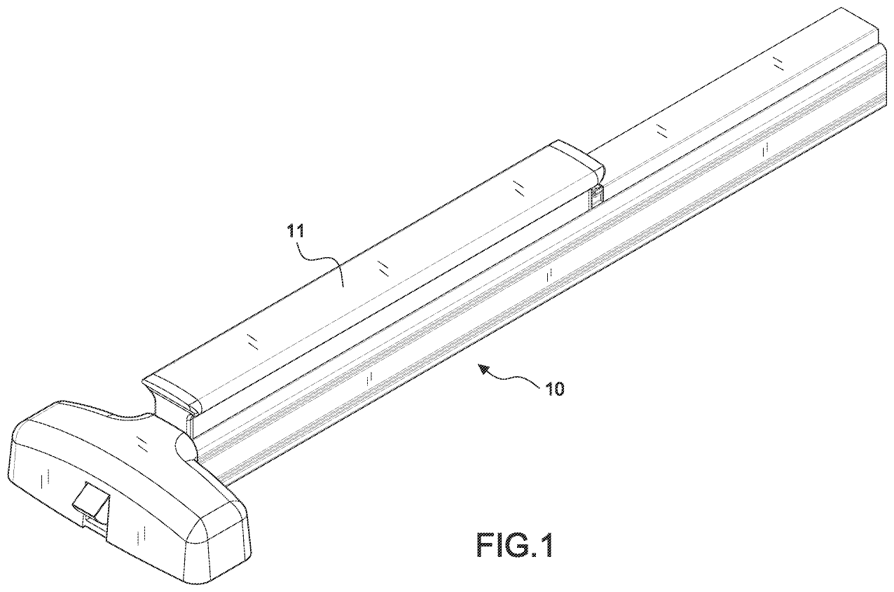

FIG. 2 is a perspective view of the present invention;

FIG. 3 is an exploded perspective view of the main structure of the present invention;

FIG. 4 is a front view o of the present invention in locking status;

FIG. 5 is a front view of the present invention in unlocking status;

FIG. 6 is a sectional view of the present invention combined with the push bar latch in locking status;

FIG. 7 is a sectional view o of the present invention combined with the push bar latch in unlocking status.

### DETAILED DESCRIPTION OF THE PREFERRED EMBODIMENT

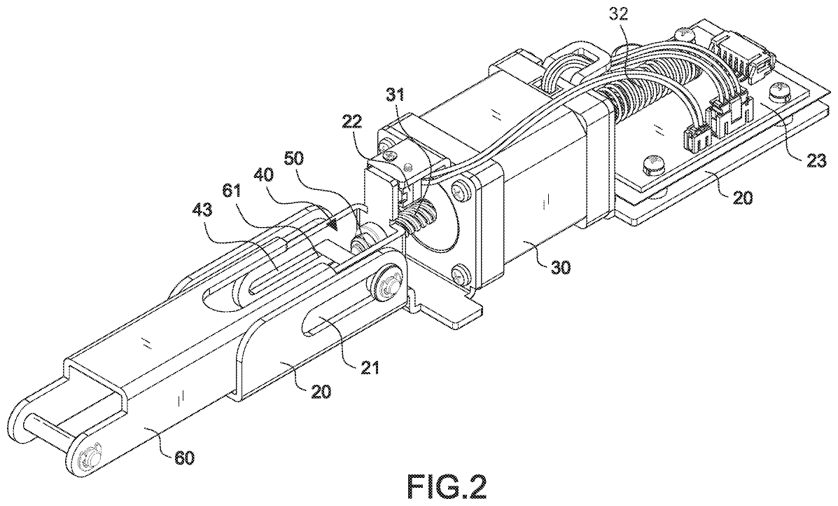

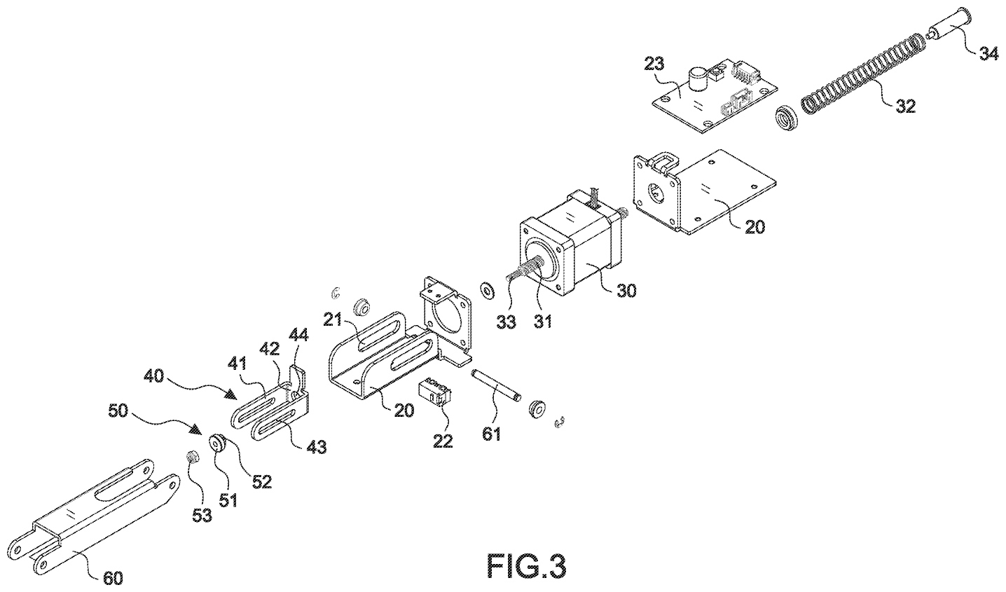

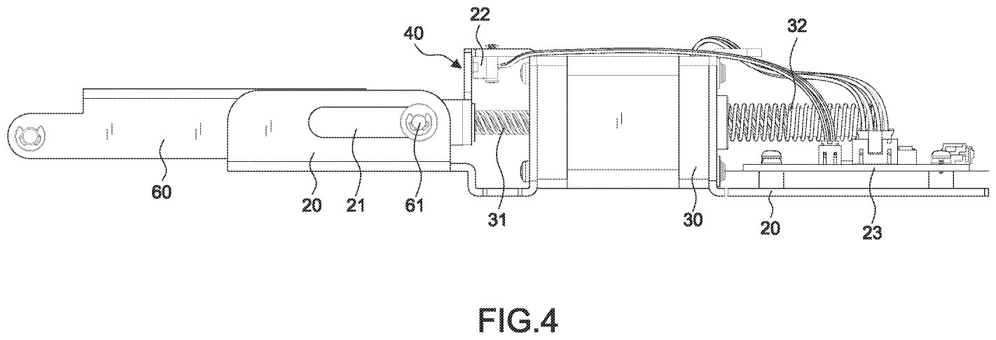

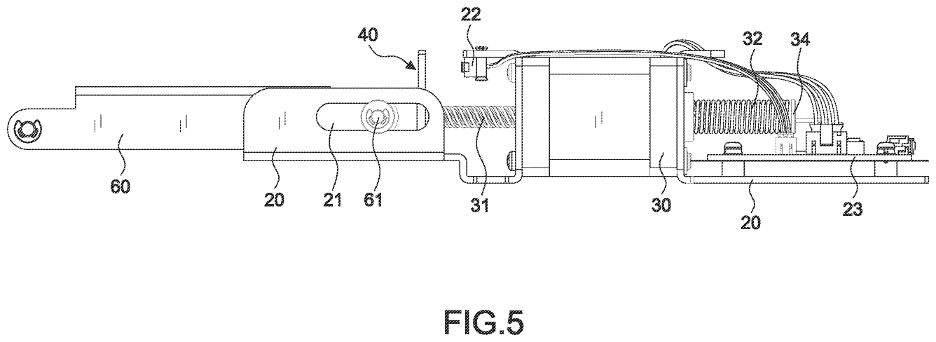

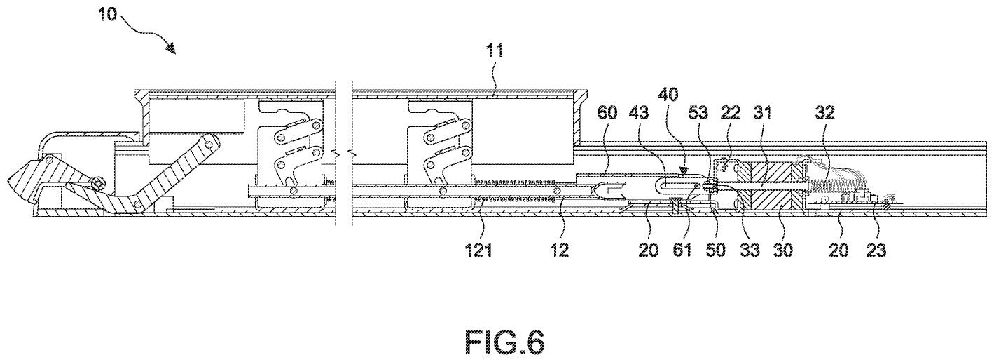

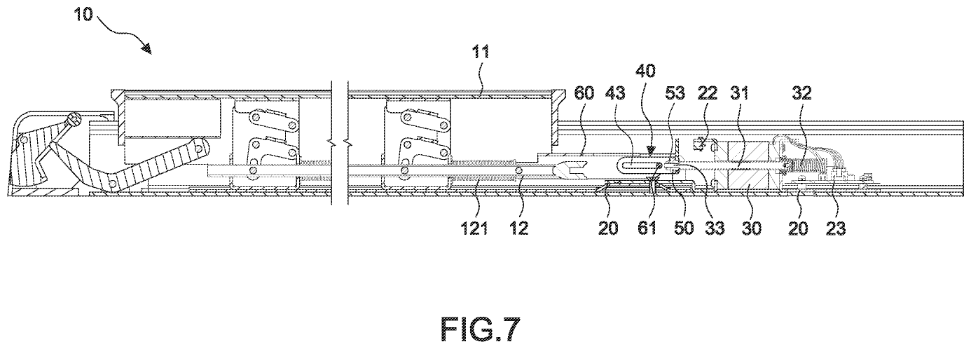

Referring to FIGS. 2-7, the present invention, including: a base frame 20 having an external sliding slot 21; a linear motor 30 having a stepping stud 31 installed on the base frame 20, the stepping stud 31 extends and retracts relative to the external sliding slot 21 and is equipped with a stud return spring 32, and the head end of the stepping stud 31 has a binding rod 33, the stud return spring 32 is sleeved at the tail section of the stepping stud 31 and fixed by a positioning post 34, the positioning post 34 is combined with the tail end of the stepping stud 31; an unlocking unit 40 having a pair of side plate 41 and an end plate 42 arranged in the base frame 20, the pair of side plate 41 has a pair of internal sliding slot 43 relative to the external sliding slot 21, and the end plate 42 has a non-circular hole 44; a transmission unit 50 having a limit oval head rivet 51 and a non-circular barrel 52, the non-circular barrel 52 sets through the non-circular hole 44 and makes the limit oval head rivet 51 arranged inside the unlocking unit 40, and makes the transmission unit 50 combine with the binding rod 33 through a binding unit 53, then let the unlocking unit 40 slide along with the extension of the stepping stud 31; a position sensor 22, arranged on the base frame 20 to define the pre-unlock reference position of the unlocking unit 40, wherein the position sensor 22 includes a limit switch, a micro switch a proximity switch, a optocoupler, a hall device or a laser diode which can sensing distance; an unlocking connecting rod 60, the outer end of the unlocking connecting rod 60 is combined with a push bar returning unit 12 of a push bar latch 10, and the inner end is provided with an unlocking pin 61, the unlocking pin 61 sets through the pair of external sliding slot 21 and the pair of internal sliding slot 43.

Whereby the embodiment of the present invention is a forward push-to-unlock type with the push bar returning unit 12, when the linear motor 30 is energized to make the stepping stud 31 move forward, the unlocking unit 40 pushes the unlocking connecting rod 60 through the unlocking pin 61 and moves forward together in the external sliding slot 21, and the unlocking connecting rod 60 can link the push bar returning unit 12 to make the push bar latch 10 electrically unlock; when the linear motor 30 is powered off, the stepping stud 31 uses the stud return spring 32 to return to its original position; in addition, when the push rod 11 is pushed horizontally to unlock manually, the push bar returning unit 12 will link the unlocking connecting rod 60 to move forward, however, because the unlocking pin 61 can move forward in the pair of internal sliding slot 43, the unlocking connecting rod 60 will not link the unlocking unit 40, and will not affect the manual unlocking action of the push bar latch 10, the push bar returning unit 12 is equipped with a compression spring 121 to make the push bar latch 10 automatically return to the locked state.

Moreover, the control unit 23 is used for the initial setting of the unlocking steps in the initial installation of the push bar latch (in order to meet the needs of the market, the electric unlocking device can be easily installed on various brands, because the strokes of the push bar latch of various manufacturers and brands are different, so the number of steps required to unlock will be different), or reset the number of steps to unlock due to abnormal unlocking; the setting method is first making the stepping stud 31 retract then confirm the pre-unlock reference position of the unlocking unit 40 through the position sensor 22, then makes the stepping stud 31 continue to push the unlocking unit 40 outward in a slow speed until the stepping stud 31 having out-of-step phenomenon, (at this time, it is completely unlocked state, so that the stepping stud 31 is subject to great resistance), and when the out-of-step phenomenon occurs, sets the running step of the stepping stud 31 as maximum step, and the unlocking step of the stepping stud 31 is set to be lower than the maximum step and memorized, then the stepping stud 31 retracts to let the unlocking unit 40 be at the pre-unlock reference position, and push the unlocking unit 40 outward according to the unlocking step to operate the unlock process; wherein the unlocking step is 94%±5% of maximum step, the initial/resetting of the number of unlocking steps can be performed manually or automatically.

With the feature disclosed above, the present invention is combined with the push bar latch and uses the stepping stud 31 of the linear motor 30 to push/pull the unlocking unit 40, and then moves the push bar returning member 12 through the unlocking connecting rod 60, so that the push bar latch can be electrically unlocked, and has effect of having the electric unlocking function of the door lock; wherein, the unlocking operate pattern of the present invention which the stepping stud 31 retracts to let the unlocking unit 40 be at the pre-unlock reference position, and push the unlocking unit 40 outward according to the unlocking step to operate the unlock process, this operate pattern has defined the standard for the electric unlocking, and has the effect of ensuring that the electric unlocking does not fail; However, in addition to the push bar type, the returning unit of the push bar latch is also designed with a rotary type and lasso returning type, it can also achieve the purpose of electric unlocking through the unlocking connecting rod of different structures.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An electric unlocking device for a push bar latch, comprising:
a base frame having an external sliding slot;
a linear motor having a stepping stud installed on the base frame, the stepping stud extends and retracts relative to the external sliding slot and is equipped with a stud return spring, and the head end of the stepping stud has a binding rod;
an unlocking unit having a pair of side plate and an end plate arranged in the base frame, the pair of side plate has a pair of internal sliding slot relative to the external sliding slot, and the end plate has a non-circular hole;
a transmission unit having a limit oval head rivet and a non-circular barrel, the non-circular barrel sets through the non-circular hole and makes the limit oval head rivet arranged inside the unlocking unit, and makes the transmission unit combine with the binding rod, then let the unlocking unit slide along with the extension of the stepping stud;
a position sensor, arranged on the base frame to define the pre-unlock reference position of the unlocking unit;
a control unit, electrically connected to the linear motor and the position sensor; and
an unlocking connecting rod, the outer end of the unlocking connecting rod is combined with a push bar returning unit, and the inner end is provided with an unlocking pin, the unlocking pin sets through the pair of external sliding slot and the pair of internal sliding slot.

2. The electric unlocking device for a push bar latch as claimed in claim 1, wherein when the control unit sets the number of unlocking step, it firstly makes the stepping stud retract then confirm the pre-unlock reference position through the position sensor, then makes the stepping stud continue to push the unlocking unit outward in a slow speed until the stepping stud having out-of-step phenomenon, thus when the out-of-step phenomenon occurs, sets the running step of the stepping stud as maximum step, and the unlocking step of the stepping stud is set to be lower than the maximum step and be memorized, then the stepping stud retracts to let the unlocking unit be at the pre-unlock reference position, and then the stepping stud is unlocked according to the unlocking step.

3. The electric unlocking device for a push bar latch as claimed in claim 2, the unlocking step is 94%±5% of maximum step.

4. The electric unlocking device for a push bar latch as claimed in claim 1, wherein the position sensor includes a limit switch, a micro switch a proximity switch, a optocoupler, a hall device or a laser diode which can sensing distance.
